(19) United States
(12) Patent Application Publication
(10) Pub. No.: US 2009/0123126 A1
(43) Pub. Date: May 14, 2009

(54) System and Method for Inferring Power Status of a Content Source

(76) Inventors: Mark Gilmore Mears, Zionsville, IN (US); Valerie Sacrez Liebhold, Ashland, MA (US)

Correspondence Address: Robert D. Shedd;Thomson Licensing LLC, PO Box 5312, PRINCETON, NJ, 08543-5312, US

(21) Appl. No.: 11/990,296

(22) PCT Filed: Aug. 26, 2005
(86) PCT No.: PCT/US2005/030522

§ 371 Date: Feb. 11, 2008

(30) Foreign Application Priority Data
Sep. 26, 2005 (JP) 2005-278095

(51) Int. Cl. H04N 5/91; H04N 7/26

(52) U.S. Cl. 386/83; 386/124

(57) ABSTRACT

A system, apparatus and method for recording media content include an input in communication with a content source for receiving media content therefrom. An input sensor detects whether a signal indicative of the media content is present on the input for a scheduled event. If no signal is detected at the input by the input sensor, a command module communicates a power-toggle control signal to the content source to activate the content source such that the input receives the content signal which is then sensed by the input sensor.

### FIELD OF THE INVENTION

The present invention generally relates to video recording systems and methods and, more particularly, to a system and method where a video recorder infers a power status of the video source.

### BACKGROUND OF THE INVENTION

Remotes or other control equipment may periodically request components or a user to reply with the state that the equipment is in so that the components can be synchronized. There are remotes (e.g., HARMONY™) that periodically inquire of a user as to what state the system components are in so that these components can be synched up. In a personal video recorder (PVR) device (e.g., TIVO™, REPLAYTV™), the user can set up infrared (IR) blaster cables (i.e., IR controller cables) (or other control cables, like RS-232) and video recording timers to record video from a set-top box video source (like a satellite receiver, cable box, etc.). At a specific time, the PVR IR-blasts the set-top box to tune to a specific channel. The PVR records the video content emanating from the set-top box and stores it in PVR memory. However in conventional recording systems, the PVR does not control the power on/off status of the content source.

The problem in the art is that a content recorder, such as a PVR, has no way of knowing whether the content source, such as a set-top, is on or off (e.g., its power state). In addition, the PVR has no way of configuring the set-top box into a known state (i.e., on or off) to ensure successful recording. A major reason is because the majority of consumer electronic products are TOADs (Toggle Only Actuated Devices). TOADs respond to only one power command POWER TOGGLE—and they do not respond to discrete POWER ON and discrete POWER OFF in addition to POWER TOGGLE commands.

### SUMMARY OF THE INVENTION

The present invention provides a system, apparatus and method for recording media content where a recording device infers the power status or state of a content source. That is, in accordance with the present invention, the power state of a content source is detected and manipulated. In one embodiment of the present invention, a content recorder or video recording system for recording content includes an input in communication with a content source for receiving content therefrom. An input sensor detects whether a signal indicative of content from the content source is present on the input for a scheduled event. If no signal is detected at the input, a command module sends a power-toggle control signal to the content source to activate the content source to cause media content to be communicated to the input of the recording device.

In an alternate embodiment of the present invention, a method for recording content includes the steps of at a content recorder, detecting for the presence of an input signal from a content source and if the input signal is not detected, communicating a power toggle control signal from the content recorder to the content source to cause the content source to be activated such that the content recorder begins sending content to the content recorder. The method further includes recording, via the content recorder, received content from the activated content source.

### BRIEF DESCRIPTION OF THE DRAWINGS

The teachings of the present invention can be readily understood by considering the following detailed description in conjunction with the accompanying drawings, in which:

FIG. 1 depicts a high level block diagram of an exemplary system for recording content in accordance with one embodiment of the present invention;

FIG. 2 depicts a high level block diagram of a video recording system in accordance with an alternate embodiment of the present invention;

FIG. 3 depicts a flow diagram of a method for recording content in accordance with one embodiment of the present invention; and

FIG. 4 depicts a flow diagram of a method for testing a command set in accordance with one embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention provides a system and method for enhancing video recording systems. A video or audio playback device, such as a personal video recorder (PVR), a video playback device or other playback device includes a function which selectively activates and deactivates the set-top box or other device to turn the device on or off in accordance with the other functions performed by the playback device. Although the present invention will be described primarily within the context of a video recording system, the present invention is much broader and may include any digital multimedia system, which is capable of delivery over a network. In addition, the present invention is applicable to any recording method including recording data taken by telephone, set-top boxes, computer, satellite links, etc. Even further, although the present invention is described in terms of a cable or satellite network, the concepts of the present invention may be extended to other wireless and wired network types.

It should be understood that the elements shown in the FIGS. may be implemented in various forms of hardware, software or combinations thereof. Preferably, these elements are implemented in a combination of hardware and software on one or more appropriately programmed general-purpose devices, which may include a processor, memory and input/output interfaces.

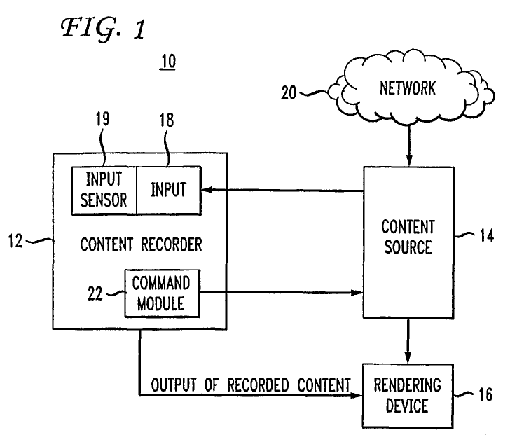

FIG. 1 depicts a high level block diagram of an exemplary system for recording content in accordance with one embodiment of the present invention. In FIG. 1, an illustrative system 10 depicts an enhanced content recording system 10 in accordance with an exemplary embodiment of the present invention. The details of the individual block components making up the system architecture that are known to skilled artisans, will only be described in details sufficient for an understanding of the present invention. Content recording system 10 of FIG. 1 comprises a content source 14, a rendering device 16, and a content recorder 12 including an input 18, an inputs sensor 19 and a command module 22. In the content recording system 10 of FIG. 1, the content source 14, receives a signal from or through a network 20. Network 20 may include a cable, satellite, telephone (wired or wireless) or any other type of network capable of delivering digital content to a source 14. Although with respect to FIG. 1, the source 14 will be described in terms of a set-top box, a content source may include a video source such as a television or display, or other sources of content such as modems, satellite receivers, etc.

The content recorder 12 is programmed or controlled to record data (e.g., video) from the content source 14. The content recorder 12 may include a video recorder, such as a VCR, DVD recorder, personal video recorder, an audio recorder or any other content recording device. For simplicity, embodiments of the present invention will be described in terms of a video source and video recorder, although other sources and recording devices are contemplated.

To judge whether the external video source 14 is on, the video recorder 12 checks its own video input 18 for the presence of video. If video is not detected on the video input 18, the video recorder 12 presumes that the video source 14 is off and communicates (i.e., blasts) an infrared power toggle command from a command module 22 to the video source to turn on the video source 14. The input sensor 19 is employed to detect whether a signal is present at the input 18. The sensor 19 can include any device capable of detecting a signal at the input 18 (e.g., detecting energy or voltage changes, etc.). After a scheduled event or failure to receive an input signal, a power toggle command is communicated by the video recorder 12 to the video source 14 to turn off power and save energy. The content rendering device 16 may include a display, a television, a speaker, or any other rendering device for rendering the content of system 10.

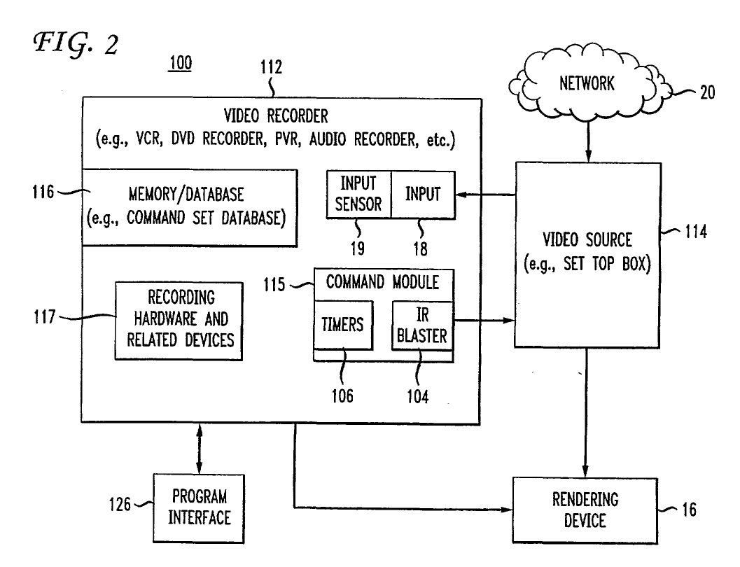

FIG. 2 depicts a high level block diagram of a video recording system in accordance with an alternate embodiment of the present invention. In the video recording system 100 of FIG. 2 a personal video recorder (PVR) device 112 (e.g., TIVO™, REPLAYTV™) is connected to a set-top box 114. A user can configure a command module 115 which may include IR blaster cables (or IR controller cables) 104 and video recording timers 106 in the recorder 112 to record video from the set-top box (video source) 114. At a specific time, the PVR 112 communicates an IR-blast to the set-top box 114 to tune the set-top box 114 to a specific channel. The PVR 112 records the video content communicated from the set-top box 114 and stores the content in a PVR memory 116. Advantageously, the PVR communicates an IR-blast the set-top box 114 to enable a power toggle command from the command module 115.

The set-top box 114 is configured to respond to POWER TOGGLE infrared commands from the command module 115 such that the PVR 112 is able to IR blast a POWER TOGGLE command to the set-top box 114 and configure the set-top box 114 into a known state (e.g., a “power on” state). However, because set-top boxes do not typically respond to power on and power off queries, in such instances the PVR 112 is configured to detect video from such a set-top box to determine whether the set-top box is an on or off state. For example, if the PVR 112 senses no video, then the PVR 112 assumes that the set-top box is off and communicates an IR blast to POWER TOGGLE the set-top box. The PVR or other recording device of the present invention may include a database 116 of IR protocols (frequencies) and commands that permits the recording device to control a particular brand of receiver (e.g., set-top box or content source 114).

Alternatively, a user may set a PVR or other recording device of the present invention to control a set-top box by performing a configuration process in the PVR or recording device. For example, such a test may involve a user choosing his brand of receiver from a list in the PVR's menu, then performing a test to ensure that the brand was chosen correctly by, for example, communicating an IR blast from the PVR to the set-top box successful to turn the set-top box on or off or change the channel on the set-top box. If the test is unsuccessful, then the PVR prompts the user to start the test for the next “code set” of the same brand (if available) until all code sets for that brand are exhausted.

In an alternate embodiment of the present invention, the selection of the set-top box brand from the list of brands is performed automatically by cycling through the command sets in stored in the recorder and detecting whether the last command set worked appropriately. In such an embodiment, the PVR could autodetect the state of the set-top box by using the video input signal as feedback for the determination of the state of the set-top box. If the appropriate input signal is received, the PVR adopts the successful command set. The auto detection of the set-top box may be performed with little or no user intervention (e.g., all brands may be tested automatically by cycling through the command sets) and may be performed at setup and intermittently checked or rerun to update the command set if desired or needed. For example, in one embodiment of the present invention, if no video is detected after the test of a “Brand “A” or Code Set 1”, then the PVR automatically moves on to test a “Brand “A” Code Set 2”, then 3, 4, etc. until all brand and code set IR protocols have been tested. At that time, the PVR may prompt a user to retry the same brand of set-top boxes or to move on to another brand of set-top boxes to test.

In conventional systems, users are encouraged to always keep the set-top box in an “on” state. However, some energy-conscious consumers may prefer to turn off their set-top box. In addition, other consumers may accidentally turn off their set-top box. Unfortunately, having the set-top box in the off-state is prevents the PVR from receiving and recording video from the set-top box. As such and in accordance with one embodiment of the present invention, when the PVR 112 is preparing to begin a recording from a set-top box 114, the PVR 112 attempts to detect a video signal before initializing (i.e., changing a channel) a recording. That is, the PVR 112 checks an input of the set-top box 114 for the presence of a video signal. The PVR 112 is aware of which of the PVR's inputs is connected to the set-top box 114 because the PVR 112 queries the set-top box 114 for this information in a setup process. If the presence of video on the specified PVR video input 18 is not detected by a sensor 19, the PVR 112 presumes that the set-top box 114 is in the “off” state. In such a case, the PVR infrared-blasts a POWER TOGGLE command to the set-top box to configure the set-top box 114 to the “on” state. If power (e.g., an input signal) is detected, then the PVR IR communicates a channel change command to the set-top box 114 as the PVR 112 normally would to tune the set-top box 114 to a preferred channel to be recorded. If, however, no input signal is detected, the PVR 112 repeats the POWER TOGGLE command via IR blasting to the set-top box 114. The PVR 112 could repeat this cycle for a predetermined number of times (e.g., three times) or until the PVR 112 detects video from the input where the set-top box 114 is connected. If no video is detected after the final attempt to POWER TOGGLE the set-top box to turn it on, the PVR 112 may cancel the recording.

Recording hardware and related devices may include the needed instrumentation to record content from the source 114. Recording hardware and related devices 117 may include software programs used to permit a user to program the recorder 112 (e.g., using a program interface 126). The program interface 126 may include a keypad, a remote control or any other interface capable of configuring the recorder 112. A content rendering device 16 may include a video display, a television, a speaker, or any other rendering device for rendering content. Although the concepts of the present invention have been described and depicted herein with respect to video recorders (e.g., VCRs, PVRs) in which the video recorder blasts a set-top box and that set-top box's video is fed back to the video recorder (i.e., closed loop systems), it should be understood that in alternate embodiments of the present inventions, control signals may be communicated from a recording device (e.g., a PVR) to a content source via other electromagnetic radiation signals or even wired connections.

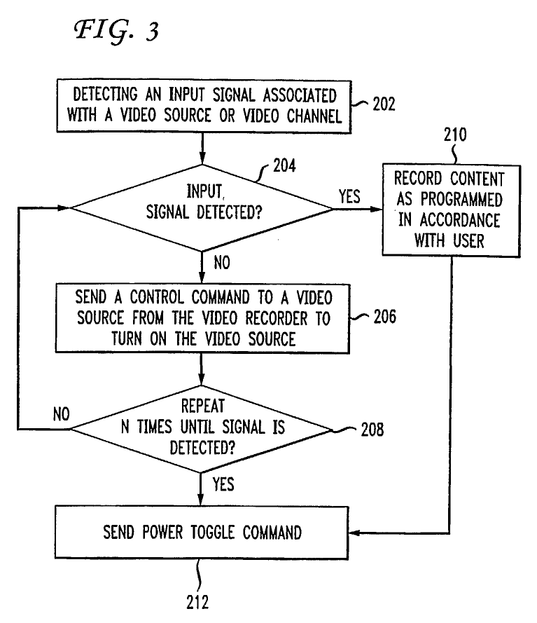

FIG. 3 depicts a flow diagram of a method for recording content in accordance with one embodiment of the present invention where the power status of a content source is inferred by the recording mechanism. Typically, a video recorder includes a program having stored dates and times or codes for identifying programs to record and the recorder is configured to select the appropriate channel for recording. The method of FIG. 3 begins in block 202, where the recorder checks/detects the power state of the video source using an input sensor which checks for the presence of video on the video recorder's video input. This step may be performed prior to a channel change command, for example, or during a setup phase for determining appropriate brand and code set commands. In block 204, it is determined if a signal has been detected. If there is no video, in block 206 the PVR communicates a POWER TOGGLE command to the set-top box to attempt to configure the set-top box turn to the “on” state. In block 208, this is repeated for a predetermined number of times or until an appropriate signal is detected. In one embodiment, an autodetect feature may be employed to detect an input based on a selected command set during startup. For example, during setup, the recorder may go through a list of brand types and code sets until an active input signal is available. This active input signal provides feedback indicating that the appropriate brand and code set have been selected, and that further searching or detecting is unnecessary.

In block 210, video is recorded if a signal is received. The recording is made in accordance with user program criteria. In block 212, the video recorder optionally communicates a POWER TOGGLE command to the set-top box to attempt to configure the set-top box turn to the “off” state. As such, it is no longer necessary to remember whether the video source 14 is in the “on” or “off” state before recording. It also alleviates a user from having to remember to keep the set-top box in the “on” state or the “off” state since the video recorder can control this directly.

In accordance with the present invention, the state of a video source is detected based on a component's power state rather then having to request this information from the device. Requesting such information is no longer necessary since the video recorder includes a controller which is capable of sending a power toggle command to the video source in accordance with a timed event. Although the concepts of the present invention are described above with respect to the recording of video signals, the system and method of the present invention may be applied to audio-only products and audio recorders (e.g., satellite radio, etc.) or any other scheduled recording devices.

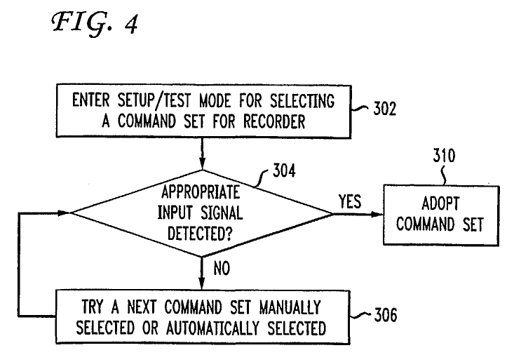

FIG. 4 depicts a flow diagram of a method for testing a command set in accordance with one embodiment of the present invention. Referring to FIG. 4, a recording device of the present invention may include a stored database of command sets (e.g., IR protocols (frequencies) and commands) that permit the recording device to control a particular brand of receiver (e.g., set-top box or content source). The method of FIG. 4 begins in block 302, where a user selects the model of the set-top box to be controlled by the recorder by running a test in the recording device. As described above, the test may involve the user picking his brand of receiver from a list in the recorder's menu and then testing that brand (e.g., is the PVR's IR blasting of the set-top box successful in controlling the set-top box). If the test is unsuccessful, then the recorder asks the user to start the test for the next “code set” of the same brand (if available) until all code sets for that brand are exhausted.

More specifically, in block 304 it is determined if an appropriate command set was used. That is, in block 304 it is determined if an appropriate response signal from the video source was received. If so, the method skips to block 310. If not, the method continues to block 306.

In block 306, a user may select another set-top box brand from the list of brands, or alternatively, this may be performed automatically by cycling through the command sets in block 306 and detecting whether the last command set worked appropriately in block 304. That is, instead of making an inquiry each time whether the set-top box was turned on or off, the PVR could autodetect this because of the video input signal acts as feedback to this determination. If the appropriate input signal is received, the recorder adopts this command set in block 310. The steps of FIG. 4 may be integrated, combined and used in conjunction with the-steps of the method of FIG. 3.

Having described preferred embodiments for system and method for inferring power status of a video source (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims. While the forgoing is directed to various embodiments of the present invention, other and further embodiments of the invention may be devised without departing from the basic scope thereof. As such, the appropriate scope of the invention is to be determined according to the claims, which follow.

1. A content recorder for recording content from a network during a scheduled event, comprising:
an input in communication with a content source for receiving content therefrom;
an input sensor for detecting whether a signal indicative of content from the content source is present on the input for a scheduled event; and
a command module which sends a power toggle control signal to the content source if no signal has been detected at the input.

2. The content recorder as recited in claim 1, wherein the command module comprises infrared blaster cables to communicate control signals.

3. The content recorder as recited in claim 1, wherein the content recorder comprises at least one of a video cassette recorder, a personal video recorder and a digital video disk recorder.

4. The content recorder as recited in claim 1, wherein the scheduled event includes a time and a channel on which the content recorder is to record content.

5. The content recorder as recited in claim 1, wherein the content recorder sends a power toggle command to the content source after the scheduled event.

6. The content recorder as recited in claim 1, wherein the content source comprises a set-top box.

7. The content recorder as recited in claim 1, wherein the content recorder selects a command set from a list of command sets using a signal detected by the input sensor as feedback that a correct command set has been selected.

8. A system for recording video during a scheduled event, comprising:
a video source for providing video content; and
a video recorder including:
an input for receiving video content from said video source;
an input sensor which detects whether a video signal is present on the input; and
a command module which provides a power toggle control signal to said video source if no signal is detected at the input, the power toggle control signal configured to cause said video source to be activated such that said input receives video content from said video source and said input sensor detects the received video signal.

9. The system as recited in claim 8, wherein the command module comprises infrared blaster cables to communicate control signals.

10. The system as recited in claim 8, wherein the video recorder comprises at least one of a video cassette recorder, a personal video recorder and a digital video disk recorder.

11. The system as recited in claim 8, wherein the scheduled event includes a time and channel on which the video recorder is to record content.

12. The system as recited in claim 8, wherein the video recorder sends a power toggle control signal to the video source after the scheduled event.

13. The system as recited in claim 8, wherein the video source comprises a set-top box.

14. The system as recited in claim 8, wherein the video recorder selects a command set from a list of command sets using a signal detected by the input sensor as feedback that a correct command set has been selected.

15. A method for recording content, comprising the steps of:
at a content recorder, detecting for the presence of an input signal from a content source;
if the input signal is not detected, communicating a power toggle control signal from the content recorder to the content source to cause the content source to be activated such that the content recorder begins sending content to the content recorder; and
recording, via the content recorder, received content from the activated content source.

16. The method as recited in claim 15, wherein the step of detecting the input signal is performed using an input sensor.

17. The method as recited in claim 15, wherein the step of communicating a control signal includes sending infrared signals to the content source.

18. The method as recited in claim 15, wherein the content recorder includes at least one of a video cassette recorder, a personal video recorder and a digital video disk recorder.

19. The method as recited in claim 15, further comprising sending a power toggle control signal to turn off the content source after the recording of the received content from the content source.

20. The method as recited in claim 15, wherein the step of detecting includes selecting a command set from a list of command sets using a signal detected by the input sensor as feedback that a correct command set has been selected.

21. The method as recited in claim 15, further comprising the step of repeating the step of sending a control command until a content signal is detected at the input or for a predetermined number of attempts.
